(19) United States
(12) Patent Application Publication
(10) Pub. No.: US 2023/0378854 A1
(43) Pub. Date: Nov. 23, 2023

(54) Electrical Machine, Method, and System

(71) Applicant: Siemens Aktiengesellschaft, München (DE)

(72) Inventors: Carsten Schuh, Baldham (DE); Thomas Soller, Deggendorf, Bayern (DE); Rolf Vollmer, Gersfeld (DE)

(73) Assignee: Siemens Aktiengesellschaft, München (DE)

(21) Appl. No.: 18/246,766

(22) PCT Filed: Sep. 28, 2021
(86) PCT No.: PCT/EP2021/076612

§ 371 Date: Mar. 27, 2023

(30) Foreign Application Priority Data
Sep. 29, 2020 (EP) 20198928.2

(51) Int. Cl. H02K 15/02; B33Y 10/00; B33Y 80/00; H02K 1/12

(52) U.S. Cl. CPC H02K 15/02; B33Y 10/00; B33Y 80/00; H02K 1/12; H02K 2215/00

(57) ABSTRACT

Various embodiments of the teachings herein include an electrical machine. The electrical machine may include a rotor and/or a stator with a stack of soft magnetic laminations. Each soft magnetic lamination has a first respective flat side and a second respective flat side facing away from the first one. Each soft magnetic lamination tapers from the first flat side to the second flat side. Each of the soft magnetic laminations in the stack are oriented with the respective second flat side in the same direction.

### CROSS-REFERENCE TO RELATED APPLICATIONS

This application is a U.S. National Stage Application of International Application No. PCT/EP2021/076612 filed Sep. 28, 2021, which designates the United States of America, and claims priority to EP Application No. 20198928.2 filed Sep. 29, 2020, the contents of which are hereby incorporated by reference in their entirety.

### TECHNICAL FIELD

The present disclosure relates to electrical machines. Various embodiments of the teachings herein include electrical machines with a rotor and/or stator, having a stack of soft magnetic laminations, to a method for producing such an electrical machine, and/or systems with an electrical machine.

### BACKGROUND

It is known to design electrical machines with rotors and/or stators which are formed in each case with stacks of soft magnetic laminations. Such stacks of soft magnetic laminations have to be assembled and electrically insulated in a complex fashion so that no eddy currents or flashovers occur during operation of the electric motors.

### SUMMARY

The teachings of the present disclosure include improved electrical machines with a rotor/stator with a stack of soft magnetic laminations which can be manufactured in particular more quickly and cost-effectively and which in particular also can be manufactured in an improved fashion with novel manufacturing methods for producing the soft magnetic laminations. For example, some embodiments include an electrical machine with a rotor and/or stator (80), having a stack (10) of soft magnetic laminations (20) which each have a first flat side (30) and a second flat side (50) facing away from the first one (30) and which taper from the first flat side (30) to the second flat side (50), wherein the soft magnetic laminations (20) of the stack (10) are oriented with their second flat side (50) in the same direction (40).

In some embodiments, all the laminations (20) of the stack (10), preferably of the rotor and/or the stator (80), are oriented with their second flat side (50) in the same direction (40).

In some embodiments, the laminations (20) are silkscreen- and/or template-printed parts and preferably sintered parts.

In some embodiments, the laminations (20) have a surface which runs between the first (30) and the second flat side (50), preferably over the whole circumference, at an angle to a perpendicular to the first (30) and/or second flat side (50).

In some embodiments, in which the laminations (20) are manufactured by a metal paste being printed by means of silkscreen and/or template printing and being sintered on a sintering plate.

In some embodiments, the metal paste is deposited by means of the silkscreen and/or template printing, with a first flat side bearing on a printing plate and a second flat side facing away from the first flat side, in such a way that the metal paste tapers from the first to the second flat side.

In some embodiments, the printing plate forms the sintering plate.

In some embodiments, the metal paste is sintered in each case in such a way that the progression of the sinter shrinkage is optimized in the direction of a taper of the second flat side (50).

In some embodiments, a sintering plate with such high adhesive friction and/or a metal paste with such reduced flowability is used such that the sinter shrinkage on the first flat side (30) is eliminated or minimized.

As another example, some embodiments include a system with an electrical machine (100) described herein and/or produced with a method as described herein.

### BRIEF DESCRIPTION OF THE DRAWINGS

The teachings of the present disclosure are described in detail below with the aid of an exemplary embodiment illustrated in the drawings, in which:

FIG. 1 shows a stack of soft magnetic laminations of a stator of an electrical machine incorporating teachings of the present disclosure schematically in cross-section, and

FIG. 2 shows an industrial system incorporating teachings of the present disclosure with a drive with the electrical machine incorporating teachings of the present disclosure with the stator with the stack of soft magnetic laminations according to FIG. 1 schematically in a diagram.

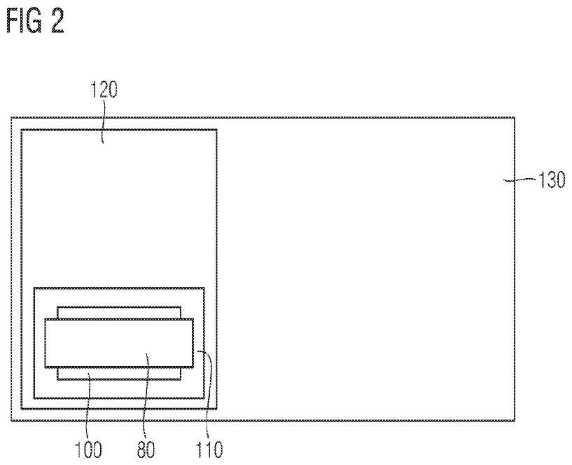

### DETAILED DESCRIPTION

The electrical machines described herein have a rotor and/or a stator which each has a stack of soft magnetic laminations. In some embodiments, the soft magnetic laminations each have a first flat side and a second flat side facing away from the first one, wherein the laminations taper from the first flat side to the second flat side. In some embodiments, the soft magnetic laminations of the stack are arranged with their second flat side oriented in the same direction.

In some embodiments, the insulation of the stack of soft magnetic laminations can be effected very easily because, as a consequence of the tapering laminations of the stack of soft magnetic laminations, the stack has a sawtooth- or barb-shaped profile in the stacking direction. An insulating layer such as in particular insulating paper can be introduced by being slid along the edge of the stack in a direction counter to that direction in which the laminations each taper. In some embodiments, the stack forms a constituent part of a stator which is introduced into a stack mount and which is electrically insulated from the stack by means of an insulating layer.

In some embodiments, this insulating layer can consequently be introduced particularly easily between the stack of soft magnetic laminations and the stack mount because, by virtue of their tapering shape, the laminations of the stack display a preferred direction in which the insulating layer can be introduced more easily between the stack and the stack mount than in the opposite direction. Because of the geometrical shape of the soft magnetic laminations of the stack of the electrical machine according to the invention, the insulating layer can be easily immobilized in its position as the insulating layer can be removed counter to this preferred direction only by overcoming a high friction resistance between the stack and the stack mount. In the case of the electrical machine according to the invention, electrical insulation can consequently be introduced easily.

It should be understood that, within the sense of the present disclosure, “laminations” can also mean printed and/or sintered parts. Within the scope of the present invention, the term “lamination” could also be replaced by the phrase “material layer or material layer structure”, wherein the material layer or the material layer structure is preferably a flat part. In other words, the term “lamination” in the present case does not necessarily imply production of the “lamination” by means of rolling. Such a “lamination” is preferably formed by means of sintering, advantageously by means of printing and subsequent sintering.

In some embodiments, the insulating layer of the electrical machine is expediently insulating paper.

In some embodiments, the electrical machine comprises a stack mount which is designed to mount the stack. In some embodiments, the electrical machine additionally comprises the insulating layer.

In some embodiments, all the laminations of the stack, e.g. of the rotor and/or the stator, are oriented in the same direction. In this way, the whole stack of soft magnetic laminations can be electrically insulated from a stack mount such that proceeding section by section in the stacking direction of the stack is not necessary. Accordingly, the electrical machine can be manufactured in a particularly uncomplex and cost-effective fashion.

In some embodiments, the soft magnetic laminations are silkscreen- and/or template-printed parts and/or sintered parts. In this way, the soft magnetic laminations can be formed particularly simply in their geometrical shape. In particular as sintered parts, the soft magnetic laminations can easily be given their shape tapering from the first to the second flat side as a consequence of sinter shrinkage.

In some embodiments, the laminations run between the first and the second flat side, e.g. over the whole circumference, at an angle to a perpendicular to the first and/or second flat side. The soft magnetic laminations therefore preferably have a frustoconical form externally, i.e. in the sense of an enveloping geometrical body. In the inside, the soft magnetic laminations can have a central passage, for example a circular cylindrical passage, which extends from the first to the second flat side.

In some embodiments, the laminations are manufactured by a metal paste being printed by means of silkscreen and/or template printing and sintered on a sintering plate. The sintering plate can suitably influence sinter shrinkage of the metal paste and achieve a form of the soft magnetic laminations which tapers from the first to the second flat side.

In some embodiments, the metal paste is deposited by means of the silkscreen and/or template printing, with a first flat side bearing on a printing plate and a second flat side facing away from the first flat side, in such a way that the metal paste tapers from the first to the second flat side. The geometrical shape of the soft magnetic laminations can be established in particular by means of 3D printing.

In some embodiments, it is convenient that the printing plate forms the sintering plate. There is consequently no need to detach the metal paste from the printing plate before the sintering. High adhesive friction between the metal paste and the sintering plate and as a result also a high degree of influence on the sinter shrinkage can thus be enabled.

In some embodiments, the metal paste is sintered in each case in such a way that the progression of the sinter shrinkage is optimized in the direction of the taper of the second flat side.

In some embodiments, a sintering plate with such high adhesive friction and/or a metal paste with such reduced flowability is used such that the sinter shrinkage on the first flat side is eliminated or minimized.

In some embodiments, a system has an electrical machine incorporating teachings of the present disclosure and/or an electrical machine produced with a method as described above.

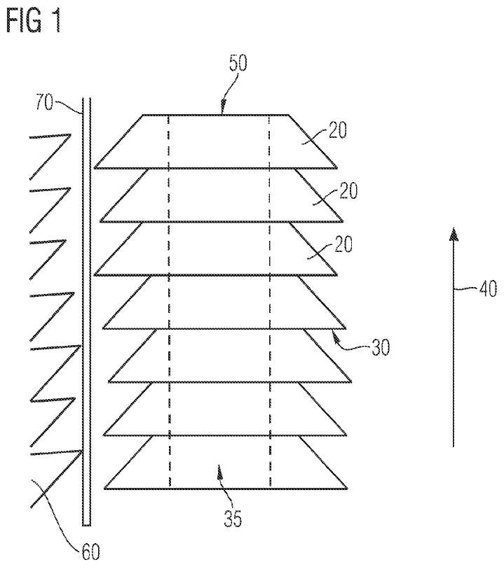

The stack 10 illustrated in FIG. 1 is formed with soft magnetic laminations 20 and forms a stator of an electrical machine incorporating teachings of the present disclosure in the form of an electric motor. The soft magnetic laminations 20 of the stack 10 are manufactured by means of silkscreen and template printing and subsequent sintering of a metal paste of soft magnetic metal, for example pure iron, and each externally have the form of a truncated cone with a circular base surface 30. Additionally, the externally frustoconical soft magnetic laminations 20 are provided with a central passage 35 in which a rotor of the electrical machine according to the invention is provided. The soft magnetic and externally frustoconical laminations 20 each taper in a stacking direction 40 from the base surface 30 to an end surface 50 having a smaller external diameter than the base surface 30 and parallel to the base surface 30.

The frustoconical form of the soft magnetic laminations 20 is implemented by means of manufacturing the soft magnetic laminations 20 by means of silkscreen and template printing and sintering: the soft magnetic laminations 20 are each printed by means of a template with an annular hole onto a substrate as a circular cylindrical green part with an inner circular cylindrical passage 35. The substrate is in each case formed with a high surface roughness such that the green part cannot follow, on its surface bearing on the substrate and which forms the later base surface 30 of the later soft magnetic lamination 20, sinter shrinkage which occurs when the green part is then sintered. The green part is subsequently sintered. Consequently, the green part shrinks far away from the bearing surface to a greater extent than at the bearing surface at which the sinter shrinkage is even completely eliminated because of the surface roughness. As a consequence of the sinter shrinkage which is different locally along the green part, an end surface of the green part which forms the later end surface 50 of the soft magnetic lamination 20 is reduced in its external diameter relative to the bearing surface such that the green part acquires an external frustoconical form during the sintering (in the inside, the originally cylindrical passage 35 likewise acquires a frustoconical form but this is not illustrated explicitly in the drawings). After the sintering, the sintered soft magnetic lamination 20 is detached from the substrate and connected to further similarly manufactured soft magnetic laminations 20 by means of an electrically insulating adhesive (not shown in the figures) to form the stack 10. The soft magnetic laminations 20 are thus connected to one another in such a way that the base surfaces 30 of the soft magnetic laminations 20 each face in the same direction (in this case in the opposite direction to the stacking direction 40). The end surfaces 50 of the soft magnetic laminations 20 of the stack 10 correspondingly face in the stacking direction 40.

The stack 10 of soft magnetic laminations 20 is held in a stack mount 60. The stack mount 60 is electrically insulated from the stack 10 by means of an insulation in the form of insulating paper 70. The insulating paper 70 can be easily pushed in between the stack 10 and the stack mount 60 in the opposite direction to the stacking direction 40, i.e. in that direction in which the base surfaces 30 of the soft magnetic laminations 20 of the stack 10 face.

In some embodiments, the external frustoconical form can be provided as early as when the green parts of the soft magnetic laminations 20 are printed such that, as described above, sintering only enhances the formation of the frustoconical form rather than being the sole cause of it. In some embodiments, the external frustoconical form can also be defined solely by 3D printing of the green part such that surface roughness of the substrate, as described above, can be omitted.

The stack 10 forms, with the insulating paper 70 and the stack mount 60, a stator 80 of an electrical machine 100 according to the invention. The passages 35 of the laminations 20 form in the stack 10 a central passage 35 which leads in the stacking direction 40. In the embodiment illustrated, the passage 35 is provided in each case when the soft magnetic laminations 20 are printed by the laminations 20 being printed as circular rings. In some embodiments, the passage 35 can also be provided be provided subsequently subtractively, for example by means of milling.

In order to form an electrical machine 100 incorporating teachings of the present disclosure, a rotor 110, which can be manufactured fundamentally in the same way as the stator 80 with the exception of the passage 35 and the stack mount 60 and the insulating paper 70 which can be omitted for a rotor 100, is introduced into the passage 35 of the stator 80. In order to form an electrical machine 100, the stator 80 is provided in a manner known per se (not explicitly shown in the drawings) with coils and an electrical supply to the coils.

In the embodiment shown, the electrical machine 100 is an electric motor and part of a drive 120 of an industrial system 130, in this case a conveyor belt system. In some embodiments, the electrical machine is an electric motor and part of a drive of an autonomous warehouse vehicle or an electric generator of an energy converter apparatus of an energy generating system, for example a power generator of a wind turbine.

What is claimed is:

1. An electrical machine comprising:
a rotor and/or a stator with a stack of soft magnetic laminations;
wherein each soft magnetic lamination has a first respective flat side and a second respective flat side facing away from the first one;
each soft magnetic lamination tapers from the first flat side to the second flat side;
each of the soft magnetic laminations in the stack is oriented with the respective second flat side in the same direction.

2. The electrical machine as claimed in claim 1, wherein all the laminations of the stack are oriented with their second flat side in the same direction.

3. The electrical machine as claimed in claim 1, wherein each of the laminations comprises a silkscreen- and/or template-printed part.

4. The electrical machine as claimed in claim 1, wherein each of the laminations has a respective surface running between the first flat side and the second flat side at an angle to a perpendicular to the first and/or second flat side.

5. A method for producing an electrical machine with a rotor and/or a stator with a stack of soft magnetic laminations, the method comprising:
manufacturing the soft magnetic laminations by printing a metal paste using silkscreen of template printing; and
sintering the soft magnetic laminations;
wherein each soft magnetic lamination has a first respective flat side and a second respective flat side facing away from the first one;
each soft magnetic lamination tapers from the first flat side to the second flat side;
each of the soft magnetic laminations in the stack is oriented with the respective second flat side in the same direction.

6. The method as claimed in claim 5, wherein the metal paste is deposited with a first flat side bearing on a printing plate and a second flat side facing away from the first flat side, so the metal paste tapers from the first to the second flat side.

7. The method as claimed in claim 5, wherein a printing plate forms a sintering plate.

8. The method as claimed in claim 5, the metal paste is sintered in each case so the progression of the sinter shrinkage is optimized in the direction of a taper of the second flat side.

9. The method as claimed in claim 1, wherein a sintering plate with such high adhesive friction and/or a metal paste with such reduced flowability is used such that the sinter shrinkage on the first flat side is eliminated or minimized.

10. (canceled)
